(19) United States
(12) Patent Application Publication
(10) Pub. No.: US 2003/0121324 A1
(43) Pub. Date: Jul. 3, 2003

(54) Fluid level indicator locking mechanism

(76) Inventor: Brian E. Beechie, Armada, MI (US)

Correspondence Address: DAIMLERCHRYSLER INTELLECTUAL CAPITAL CORPORATION, CIMS 483-02-19, 800 CHRYSLER DR EAST, AUBURN HILLS, MI, 48326-2757, US

(21) Appl. No.: 10/035,020

(22) Filed: Dec. 27, 2001

(51) Int. Cl. G01F 23/00

(52) U.S. Cl. 73/290 B; 73/290 R

(57) ABSTRACT

An apparatus for measuring the level of a fluid in a chamber is disclosed. The apparatus generally includes an indicator rod and a tubular member in fluid communication with the chamber. The indicator rod is a measuring rod operable to be immersed in the fluid in the chamber to indicate the level of fluid therein. The indicator rod also includes a locking mechanism to releasably engage the flange of the tube to restrain the movement of the indicator rod. The locking mechanism selectively engages a flange or the tube to lock the indicator rod to the tube. A seal between the indicator rod and the tube seals the chamber when the indicator is secured to the tube.

### FIELD OF THE INVENTION

The present invention relates to a device for measuring the fluid level in a chamber. More specifically, the present invention relates to a device for measuring the fluid level in a chamber having a locking mechanism and a deformable seal for sealing the measuring device to the chamber.

### BACKGROUND OF THE INVENTION

In internal combustion engines, transmissions, and other machinery requiring fluids for lubrication and cooling, it is known to use a fluid measuring device for indicating the fluid level in a participation fluid chamber. Typically, the fluid measuring device is a dipstick for checking the level of fluid. The dipstick is normally an elongated indicator that is slidably located within a conduit or tube attached to the chamber. When the dipstick is fully inserted into the tube, one end is immersed into the fluid in the chamber. When an actual reading of the fluid level is desired, the other end of the dipstick is pulled from the tube, thereby removing the entire dipstick from the conduit and chamber to allow the user to read the fluid level from the one end. The dipstick is then reinserted into the chamber once the fluid level has been checked.

The dipstick is typically coupled to the tube by a simple mechanical connection such as a sleeve. The sleeve extends over the outer surface of the tube and is held in place by gravitational or frictional forces between the sleeve and the tube. This connection, while simple and cost effective, does not prevent possible contamination of fluid in the fluid holding compartment. Additionally, it may be desirable to isolate a system from pressure changes. However, presently known devices do not allow the chamber to be sealed from external pressure changes.

### SUMMARY OF THE INVENTION

In one form, the present invention provides an apparatus for measuring the level of a fluid in a chamber. The apparatus includes an indicator rod having a first end and a second end, the first end of the indicator rod adapted to be immersed in the fluid to measure the height of the fluid in the chamber. The apparatus also includes a tube in fluid communication with the chamber having a first end connected to the chamber and the second end having a flange. A handle is coupled to the first end of the indicator rod and adapted to releasably engage the flange of the tube to restrain movement of the handle. A seal located between the handle and the tube is deformable upon engagement of the handle to the tube to form a locked and sealed interface between the tube and the handle.

Further areas of applicability of the present invention will become apparent from the detailed description provided hereinafter. It should be understood that the detailed description and specific examples, while indicating the preferred embodiment of the invention, are intended for purposes of illustration only and are not intended to limited the scope of the invention.

### BRIEF DESCRIPTION OF THE DRAWINGS

The present invention will become more fully understood from the detailed description and the accompanying drawings, wherein:

FIG. 1 is a front view of a fluid level indicator assembly in a locked position according to the present invention;

FIG. 2 is a front view of the fluid level indicator assembly of FIG. 1 in an unlocked position;

FIG. 3 is a front view of the fluid level indicator of FIG. 1; and

FIG. 4 is a cross sectional view of the tube of FIG. 1.

### DETAILED DESCRIPTION OF THE PREFERRED EMBODIMENTS

The following description of the preferred embodiment(s) is merely exemplary in nature and is in no way intended to limit the invention, its application, or uses.

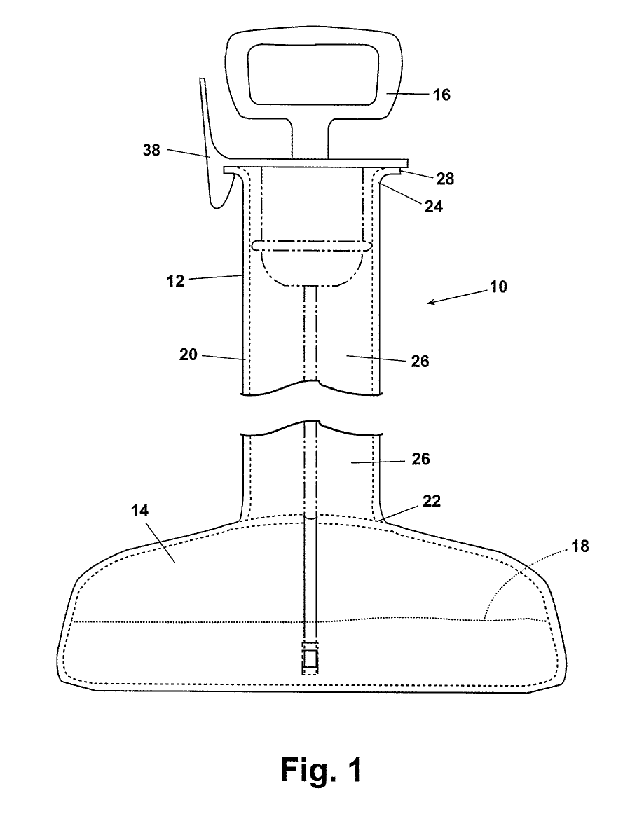

With reference to FIG. 1, a front view of a fluid level indicator assembly 10 is shown in accordance a first embodiment of the present invention. The fluid level indicator assembly 10 is shown to include a tube 12 in fluid communication with a fluid chamber 14 and an indicator 16 adapted to engage the tube 12 and extend into the fluid chamber 14. In operation, the fluid level indicator assembly 10 allows the user to check the level of the fluid 18 in the fluid holding compartment 14. The fluid level indicator assembly 10 also allows the user to attach the indicator 16 to a portion of the tube 12 using a locking mechanism 38.

The fluid level indicator 16 of the present invention is shown in combination with an exemplary fluid holding compartment 14. However, it is understood that the fluid holding compartment 14 may represent any one of a number of fluid holding compartments 14 such as a fluid lubrication system of an internal combustion engine, transmission, or other machine.

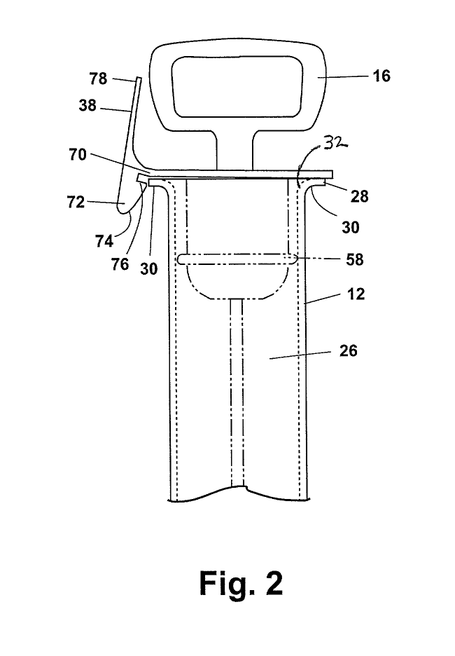

As shown in FIGS. 1-4, the tube 12 generally includes a tubular main body portion 20 having a first end 22 and a second end 24. The first end 22 of the tube 12 is connected to the fluid chamber 14 to allow fluid communication therebetween. The first end 22 of the tube 12 may be attached to the fluid holding compartment 14 using any commonly known devices such as a mechanical fitting, adhesive connection, or weld, etc. The tubular main body portion 20 is shown to be generally linear in form and have a opening 26 extending therethrough. It is readily appreciated that the tubular main body portion 20 may be formed in a variety of shapes including bends and angles to allow the tube 12 to be routed around objects and not depart from the scope of the present invention. The second end 24 of the tube 12 is formed to have a flange 28. The flange 28 allows the indicator 16 to engage the tube 12. As shown, the flange 28 extends annularly around the second end 24 of the tube 12 and includes an engagement surface 30 along the underside of the flange 28. Also, a funnel 32 is formed between the flange 28 and the opening 26 of the tube 12 to allow the indicator 16 to be guided into the opening 26 of the tube 12. However, it is appreciated that the flange 28 may be formed in a variety of configurations and not depart from the scope of the present invention.

The indicator 16 generally includes a measuring rod 34 adapted to be disposed in the tube 12, a main body portion 36 coupled to the measuring rod 34 and adapted to be partially inserted into the opening 26 of the tube 12, the locking mechanism 38 adapted to engage a portion of the flange 28, and a handle 40 allowing the user to manipulate the indicator 16.

The measuring rod 34 is an elongated member 42 having a first end 44 adapted to be immersed in the fluid 18 contained in the fluid holding compartment 14 and a second end 46 adapted to be connected to the main body portion 36. In one form, the measuring rod 34 is flexible, and may be formed of thin metal. The measuring rod 34 includes indicator marks 48 at the first end 44 to indicate the level of the fluid 18 in the fluid chamber 14.

The main body portion 36 generally includes a disk-shaped member 50 having a stopper 52 disposed at a first side thereof. The disk-shaped member 50 is formed to be at least as large as the flange 28 of the tube 12 to allow the disk-shaped member 50 to cover the flange 28. The barrel-shaped stopper 52 is formed to be a cylindrical body having a diameter 54 that is generally smaller than the diameter of the opening 26 of the tube 12. The stopper 52 also includes an annular slot (not shown) to receive a deformable seal 58, such as an o-ring. The seal 58 operatively deforms when the stopper 52 is inserted into the opening 26 of the tube 12 to create a seal between the tube 12 and the stopper 52. However, it is contemplated other deformable seals 58 such as gaskets may be used to form the seal between the stopper 52 and the tube 12.

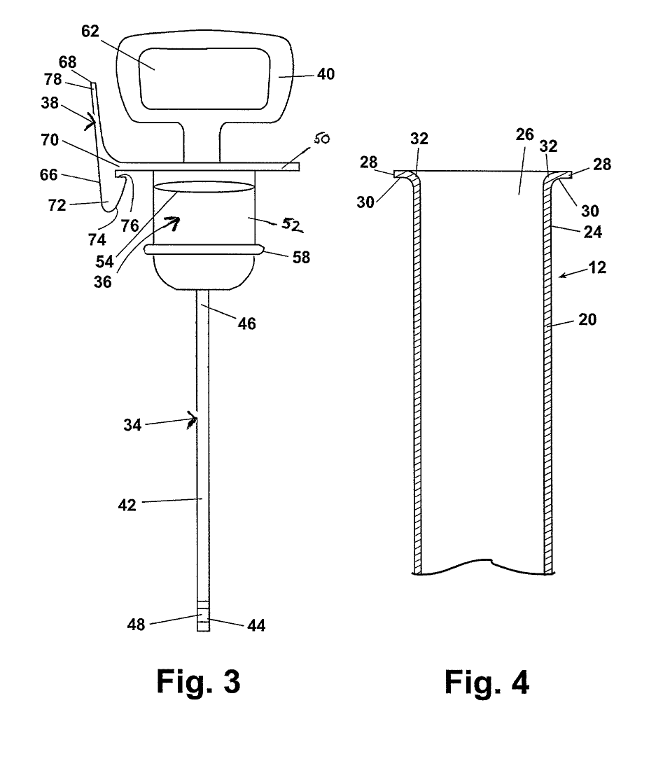

As shown in FIG. 3, the handle 40 is formed on the opposite side of the disk-shaped member 50 as the stopper 52 is formed on. The handle 40 is generally formed to include an aperture 62 to allow a portion of the user's hand to grasp the handle 40 and remove or insert the indicator 16 in the tube 12. It is appreciated that the handle 40 may be formed in a variety of different ergonomic configurations and allow for insertion and removal of the indicator 16.

The locking mechanism 38 generally includes a first end 66 and a second end 68 defined by a pivotal connection 70 to the disk-shaped member 50 of the main body portion 36. The pivotal connection 70 is shown to be a flexible member connecting the locking mechanism 38 to the main body portion 36 to allow for rotation of the locking mechanism 38 around an axis. The pivotal connection 70 is formed to be a unitary structure interconnecting the locking mechanism 38 and the main body portion 36. The pivotal connection 70 allows elastic deformation to retain the locking mechanism in a desired position. It is appreciated that the pivotal connection may be formed of several elements such as a pin and a biasing member. The first end 66 includes locking tab 72 allowing positive engagement with a portion of the flange 28 of the tube 12. The locking tab 72 includes a guide surface 74 and a locking surface 76. The guide surface 74 is oriented at an angle to allow the locking tab 72 to actuate over the edge of the flange 28 of the tube 12. Once the guide surface 74 articulates over the edge of the flange 28, the locking surface 76 engages the flange 28 to prevent axial movement of the indicator 16 in direction A. The locking surface 76 is adapted to engage the engagement surface of the flange 28 of the tube 12. The locking surface 76 is generally formed to be perpendicular to the engagement surface 30 to allow for increased contact area between the locking tab 72 and the flange 28 of the tube 12. The pivotal connection 70 interconnects the engagement mechanism 30 and the main body portion 36 and allows the first end 66 to actuate the locking tab 72.

The second end 68 of the engagement mechanism 30 generally includes a lever 78 that is operable by at least one of the user's fingers. The lever 78 is preferably positioned to allow the user to grasp the handle 40 with a portion of the handle 40 and to actuate the lever 78 with one finger.

In operation, the indicator 16 is inserted into the tube 12 by grasping the handle 40 and actuating the lever 78 of the engagement mechanism 38 inward, thus forcing the locking member tab 72 outward from the flange 28. The measuring rod 34 of the indicator 16 is then inserted in the tube 12 and the main body member 36 of the indicator 16 is moved closer to the flange 28 of the tube 12. When the disk-shaped portion 50 of the indicator 16 abuts the flange 28, the lever 78 of the engagement mechanism 38 is released and the locking surface 76 of the locking tab 72 contacts the engagement surface 30 of the flange 28.

To remove the indicator 16 from the tube 12, the handle 40 is grasped by some of the user's fingers and the lever 78 of the engagement mechanism 38 is actuated inward by at least one of the user's other fingers. Once the lever 78 is actuated inward, the indicator 16 is withdrawn from the tube 12 to allow the level of the fluid 18 to be checked by the user.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. An apparatus for measuring the level of a fluid in a chamber, the apparatus comprising:
an indicator rod having a first end and a second end, the first end of the indicator rod adapted to measure the height of the fluid in the chamber and the second end of the indicator rod having a stopper;
a tube having a first end, a second end, and an opening therethrough to selectively receive the indicator rod, the first end of the tube connected to the chamber and the second end of the tube having a flange;
a locking mechanism coupled to the stopper, releasably engaging the flange of the tube, and selectively restraining movement of the indicator; and
a seal located between the stopper and the tube, the seal deforming upon engagement with the tube to form a seal face.

2. The apparatus of claim 1 wherein the locking mechanism is operable to be actuated from a locked position to an unlocked position by one of a user's fingers.

3. The apparatus of claim 1 wherein the locking mechanism is a lever having a first portion adapted to be actuated by a user's finger and a second portion selectively engaging the flange.

4. The apparatus of claim 3 wherein the second portion includes a locking surface operably engaging the flange.

5. The apparatus of claim 1 wherein said locking mechanism is coupled to the stopper by a connection operable to allow biased rotation of the locking mechanism.

6. An apparatus for measuring the level of a fluid in a chamber, the apparatus comprised of:
an indicator rod having a first end and a second end, the first end of the indicator rod adapted to measure the height of the fluid in the chamber;
a tube having a first end, a second end, and an opening therethrough adapted to accommodate the indicator rod, the first end of the tube connected to the chamber and the second end of the tube having a flange; and
a handle having a first end, a second end, and a locking mechanism, the first end of the handle adapted to be received in the opening of the tube and coupled to the second end of the indicator rod, the second end of the handle adapted for manipulation by a user, the locking mechanism operable to releasably engage the flange of the tube to couple the indicator rod to the tube.

7. The apparatus of claim 6, further comprising a seal positioned adjacent the second of the indicator rod, the seal deformable to form a seal face upon positioning the indicator rod in the tube.

8. The apparatus of claim 6 wherein the locking mechanism is selectively actuated from a locked position to an unlocked position by a user's finger.

9. The apparatus of claim 6 wherein the locking mechanism is a lever having a first portion adapted to be actuated by a user's finger and a second portion selectively engaging the flange of the tube.

10. The apparatus of claim 9 wherein the second portion includes a locking surface operably engaging the flange.

11. The apparatus of claim 6 wherein said locking mechanism is coupled to the stopper by a connection operable to allow biased rotation of the locking mechanism.
